(19) United States
(12) Patent Application Publication
(10) Pub. No.: US 2009/0101269 A1
(43) Pub. Date: Apr. 23, 2009

(54) ADHESIVE TAPE

(75) Inventors: RONALD PFAFF, Hamburg (DE); PATRIK KOPF, Hamburg (DE); ANDREAS WAHLERS-SCHMIDLIN, Guderhandviertel (DE); ERNESTO BIASOLI, Gavirate (IT)

Correspondence Address: NORRIS, MCLAUGHLIN & MARCUS, PA, 875 THIRD AVENUE, 18TH FLOOR, NEW YORK, NY, 10022, US

(73) Assignee: tesa AG, Hamburg (DE)

(21) Appl. No.: 12/018,449

(22) Filed: Jan. 23, 2008

(30) Foreign Application Priority Data
Oct. 19, 2007 (DE) 10 2007 050 534.7
Jan. 16, 2008 (DE) 10 2008 004 713.9

(51) Int. Cl. B32B 37/12; B32B 5/02; G10K 11/16; B32B 7/12

(52) U.S. Cl. 156/60; 442/149; 181/175

(57) ABSTRACT

Adhesive tape, preferably for wrapping elongate material such as, more particularly, lines or cable looms, having a tapelike carrier composed of a weft insertion knit, and having a preferably pressure-sensitive adhesive coating applied at least to one side of the carrier, the weft yarn in the weft insertion knit being composed of a textured filament yarn.

The invention relates to an adhesive tape, preferably for wrapping elongate material such as, more particularly, lines or cable looms, having a textile carrier and having a pressure-sensitive adhesive coating applied at least to one side of the carrier. The invention further relates to the use of the adhesive tape and also to a cable harness jacketed with the adhesive tape of the invention.

In numerous sectors of industry, bundles composed of a multiplicity of electrical lines are wrapped either before installation or when already mounted, in order to reduce the space taken up by the bundle of lines, by means of bandaging, and also to obtain protective functions. With sheet adhesive tapes a certain protection against ingress of liquid is achieved; with airy and bulky adhesive tapes based on thick nonwovens or foam carriers, damping properties are obtained; and when stable, abrasion-resistant carrier materials are used a protective function against scuffing and rubbing is achieved.

The use of adhesive tapes having a nonwoven carrier for bandaging cable harnesses is known. DE 94 01 037 U, for instance, describes an adhesive tape having a tapelike textile carrier composed of a stitchbonded nonwoven formed in turn from a multiplicity of sewn-in stitches running parallel to one another. On the basis of its special make-up, the adhesive tape described exhibits noise suppression properties when it is used for cable harness bandaging.

Besides the stitchbonded web mentioned in the cited publication there are further carriers which are used in adhesive tapes for cable harness bandaging.

DE 44 42 092 C1 describes one such stitchbond-based adhesive tape, which is coated on the reverse of the carrier. DE 44 42 093 C1 is based on the use of a nonwoven web which is used as a carrier for an adhesive tape, the web being formed by the formation of loops from the fibres of the web to produce a reinforced cross-laid fibre web, in other words a web known to a person skilled in the art under the name Malifleece. DE 44 42 507 C1 discloses an adhesive tape for cable bandaging, but bases it on so-called Kunit or Multiknit webs.

DE 195 23 494 C1 discloses the use of an adhesive tape having a carrier of web material for bandaging cable harnesses, the tape being coated on one side with an adhesive. The web employed in accordance with the invention is a spunbonded polypropylene web which is thermally consolidated and embossed using a calender, the embossing area of the embossing roll being from 10% to 30%, preferably 19%.

DE 298 04 431 U1 likewise discloses the use of an adhesive tape having a web-material carrier for bandaging cable harnesses, the proposed spunbonded web being of polyester.

DE 298 19 014 U1 discloses adhesive tapes based on a nonwoven web consolidated with jets of air and/or water.

WO 99/24518 A1 describes an adhesive tape where the carrier material is a nonwoven web which finds suitability for the use of adhesive tapes only by virtue of the specific selection of fibres or filaments having a fineness of more than 15 denier and also through an additionally extruded-on film layer.

EP 1 000 992 A1 describes a perforated cotton web having a polyethylene coating 10 to 45 μm thick and also having an additional release coating.

The texturing of thread material is employed primarily for textile fabrics made of manmade fibres such as polyester or polyamide, in order to give the synthetic fibres a character resembling that of natural fibres. When spun to yarn, manmade fibres differ from natural fibres in the length of the filaments to be spun. With natural fibres, the filament length is much shorter than that of manmade fibres, amounting to just a few centimetres. When short filament lengths are spun to yarn and thread, such as in the case of cotton, for example, the protruding filament ends give the cotton a plushness and hence a pleasing hand. Differing from this, in the case of manmade fibres, continuous filaments are used, which after spinning to the yarn possess a parallel position relative to one another and give the yarn a smooth, unnatural hand.

The texturing of thread material made up of artificial continuous filaments can be performed, for example, by deforming the filaments from their parallel position, by torsion or flexure, with subsequent heat setting. One example of this is the process known as false twisting [Grundlagen der Textilveredelung, 13th revised edition, Deutsch Fachbuchverlag 1989].

On account of their pleasing tactility, textile fabrics made of manmade fibres such as polyester with textured thread material are frequently used for garment applications—for example, as the fused front in the high-value outerwear sector.

The physical measurement of the noise damping effect can be made in accordance with the method described in detail in DE 100 39 982 A1. This is a measurement methodology which is established in the automotive industry, and, for example, is also specified in the BMW standard GS 95008-3 (May 2000 issue).

The measurement method according to the BMW standard GS 95008-3 from May 2000 is set out comprehensively below in conjunction with FIGS. 1 and 2.

### BRIEF DESCRIPTION OF THE DRAWINGS

FIG. 1 shows the construction of the measuring apparatus in side elevation

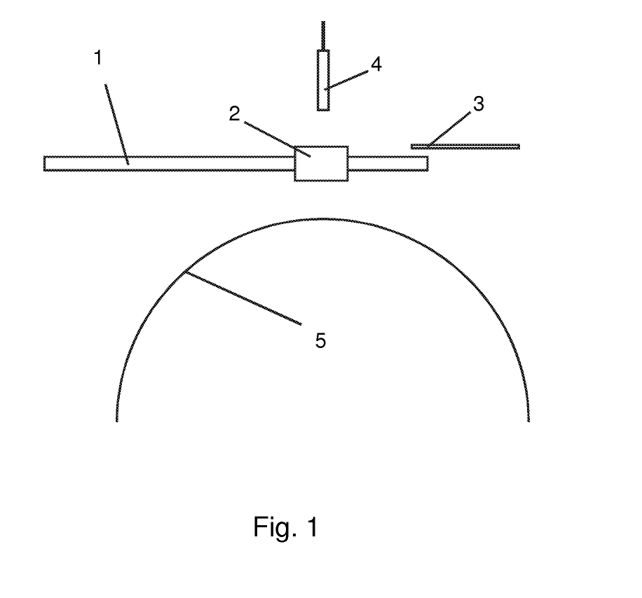

FIG. 2 shows the same construction in horizontal elevation; and

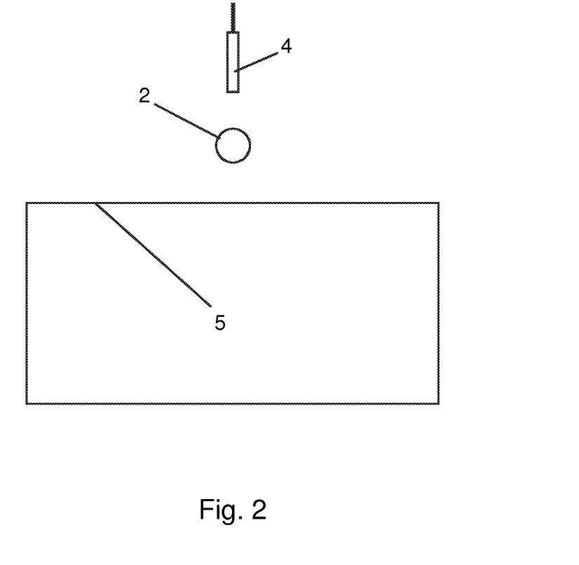

FIG. 3 shows the use of an adhesive tape of the invention in another embodiment when jacketing cables, or a cable harness.

In this measurement method a defined steel rod 1 with a diameter of 8 mm is wrapped with the test specimen 2—that is, adhesive tape—so as to give a length of 210 mm between the pivotal point of the steel rod 1 and the test specimen. The wrapped steel rod 1 is taken up to the stop 3, to the height of drop (20 mm), and is dropped with a weight of approximately 16 g onto an aluminium panel 5. The aluminium panel 5, which in the undeformed state measures 350×190×0.3 [mm], is arranged in the form of a half-barrel under the test specimen 2, so as to give an extent of 290 mm.

The overall noise outcome is detected and recorded by means of a microphone 4, located 50 mm over the point of impact, in a frequency range of, for example, 20 to 12 500 Hz, using a commercial sound meter, for example of type 2226 from Bruel & Kjaer. Particularly relevant for the human ear are frequencies in the range from 2000 to 5000 Hz.

The attenuation is reported as the difference between the blank value, with the unwrapped steel rod, and the respective measurement in dB(A).

The physical measurement of the noise damping effect can be alternatively made in accordance with the method described in LV312 “Klebebänder für Kabelsätze in Kraftfahrzeugen” (1/2005).

LV312 “Klebebänder für Kabelsätze in Kraftfahrzeugen” (1/2005) is a norm used as a common standard procedure in the companies of Audi, BMW, Daimler and VW. As important tests for application technology test methods of adhesive tapes, used for the wrapping of wire harnesses, are described in this standard procedure, e.g., test methods for compatibility of adhesive tapes with the electrical circuits in vehicles and for resistance against chemicals, noise attenuation, fogging performance and abrasion resistance.

It is an object of the invention to provide an adhesive tape which when used to jacket cables, for example, meets the required property, such as attenuation, and which ensures a jacketed product, in this case, in other words, a cable harness, which is more flexible than the existing products jacketed with the known adhesive tapes.

This object is achieved by means of an adhesive tape as is described hereinbelow.

The invention accordingly provides an adhesive tape, preferably for wrapping elongate material such as, more particularly, lines or cable looms, having a tapelike carrier composed of a weft insertion knit, and having a preferably pressure-sensitive adhesive coating applied at least to one side of the carrier. The weft yarn in the weft insertion knit is composed of a textured filament yarn.

A filament yarn is a continuous yarn composed of a multiplicity of thin threads which is spun uninterruptedly as continuous yarn of several kilometres in length and that over this entire length possesses a regular linear density.

The general expression “adhesive tape” embraces, for the purposes of this invention, all sheetlike structures, such as two-dimensionally extended sheets or sheet sections, tapes with an extended length and limited width, tape sections, diecuts, labels and the like.

In a first preferred embodiment of the invention the weft insertion knit has a basis weight of between 30 and 200 g/m², preferably between 60 and 100 g/m², more preferably between 80 and 90 g/m².

The carrier is able preferably to accommodate tensile forces in the cross direction of more than 130 N/cm, preferably more than 160 N/cm.

With further preference the weft insertion knit has a breaking force in running direction of 10 daN/(5 cm) to 20 daN/(5 cm), more particularly from 13 to 17 daN/(5 cm), and a breaking elongation in running direction of 30% to 50%, more particularly 40%.

With further preference on the weft insertion knit there is no further layer provided in the form of a film or another textile carrier.

The weft insertion knit has parallel courses, preferably 5 to 12 per centimetre, more preferably 10, very preferably 7.5.

The warp threads are composed preferably of polyester or polyamide and have a mass per unit length of 30 to 60 dtex, with particular preference between 45 and 55 dtex.

In the cross direction, in accordance with a further preferred embodiment of the invention, there is full-width weft insertion with a textured yarn with a preferred linear density of 600 to 800 dtex, preferably 650 to 700 dtex.

Preference is given to between 7 to 20, preferably between 8 to 12, more preferably 10, threads per running length in the cross direction.

With further preference the entire weft insertion knit is composed of polyester or polyamide.

In order to produce a self-adhesive tape from the carrier it is possible to employ all known adhesive systems. Besides natural or synthetic rubber based adhesives it is possible more particularly to use silicone adhesives and also polyacrylate adhesives. Preferred on account of their particular suitability as adhesives for wrapping tapes for automotive cable looms, in respect of the absence of fogging and also the outstanding compatibility with both PVC and PVC-free core insulations, are solvent-free acrylate hotmelt compositions, as described in more detail in DE 198 07 752 A1 and also in DE 100 11 788 A1. The application weight is situated within the range from 20 to 100 g/m².

The coating technology employed involves known systems, appropriate processes being those which permit an unpressurized placement of highly viscous adhesives—such as, for example, the coating of hotmelt adhesives via nozzle coating or via transfer from an anti-adhesive carrier cloth or release liner onto the carrier assembly.

A suitable adhesive is one based on acrylate hotmelt with a K value of at least 20, more particularly greater than 30 (measured in each case in 1% strength by weight solution in toluene, 25° C.), obtainable by concentrating a solution of such a composition to give a system which can be processed as a hotmelt.

Concentration may take place in appropriately equipped tanks or extruders; particularly in the case of accompanying devolatilization, a devolatilizing extruder is preferred. One such adhesive is set out in DE 43 13 008 C2. In an intermediate step, the solvent is removed completely from the acrylate compositions prepared in this way. The K value is determined more particularly in analogy to DIN 53 726.

In addition, the process removes further volatile constituents. After coating from the melt, these compositions have only small residual fractions of volatile constituents. Accordingly it is possible to take on all of the monomers/formulas that are claimed in the patent cited above.

The solution of the composition can contain 5% to 80% by weight, more particularly 30% to 70% by weight, of solvent.

Preference is given to using commercially customary solvents, more particularly low-boiling hydrocarbons, ketones, alcohols, and/or esters.

Further preference is given to using single-screw, twin-screw or multi-screw extruders having one or, more particularly, two or more devolatilizing units.

The acrylate hotmelt-based adhesive may have had benzoin derivatives incorporated into it by polymerization—for example benzoin acrylate or benzoin methacrylate, acrylic or methacrylic esters. Such benzoin derivatives are described in EP 0 578 151 A.

The acrylate hotmelt-based adhesive may be UV-crosslinked. Other types of crosslinking are also possible, however, an example being electron beam crosslinking.

In a further preferred embodiment the self-adhesive compositions used are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers.

The residual solvent content ought to be less than 1% by weight.

One adhesive which is found to be particularly suitable is a low molecular mass, pressure-sensitive, acrylate hotmelt adhesive of the kind carried under the name acResin UV or Acronal®, more particularly Acronal DS 3458, by BASF. This adhesive, with a low K value, acquires its application-compatible properties by means of a concluding, radiation-induced crosslinking operation.

Preferably, therefore, the adhesive coating is composed of an acrylate or silicone adhesive.

The adhesive may be applied in the longitudinal direction of the adhesive tape in the form of a strip whose width is lower than that of the adhesive tape carrier.

In one advantageous embodiment the coated strip has a width of 10% to 80% of the width of the carrier material. Particular preference is given to using strips having a coating of 20% to 50% of the width of the carrier material.

Depending on the particular utility it is also possible for two or more parallel strips of the adhesive to be coated on the carrier material.

The position of the strip on the carrier is freely selectable, preference being given to an arrangement directly at one of the edges of the carrier.

Finally, the adhesive tape may have a liner material with which the one or two layers of adhesive are lined until use. Suitable liner materials also include all of the materials set out comprehensively above.

Preference, however, is given to using a non-linting material such as a polymeric film or a well-sized, long-fibred paper.

If the adhesive tape described is to be of low flammability, this quality can be achieved by adding flame retardants to the carrier and/or to the adhesive. These retardants may be organobromine compounds, where appropriate together with synergists such as antimony trioxide, although, with regard to the absence of halogen from the adhesive tape, preference will be given to using red phosphorus, organophosphorus compounds, mineral compounds or intumescent compounds, such as ammonium polyphosphate, alone or in conjunction with synergists.

The adhesive tape may then have a noise damping in accordance with LV312 or BMW GS 95008-3 in single-ply measurement of more than 3 dB (A), more particularly 5 dB (A) to 6 dB (A).

The adhesive tape is preferably hand-tearable at least in the cross direction.

The adhesive tape is preferably used for jacketing elongate material such as, more particularly, cable looms, the elongate material being wrapped in the axial direction by the adhesive tape, or the adhesive tape being guided in a helical spiral around the elongate material.

Also embraced by the concept of the invention, finally, is an elongate material such as, more particularly, a cable loom, jacketed with the adhesive tape of the invention.

The invention uses a weft yarn which is composed of a filament yarn and is textured. As a result of the texturing there is so much volume produced that just a few picks/cm, 10 picks/cm for example, are enough to ensure complete coverage and to prevent strikethrough of the composition.

The use of continuous fibres reduces the risk of fibres being torn out of the open reverse face in the case of the adhesive tape.

Surprisingly the carrier is capable of accommodating very high tensile forces in the cross direction.

Normally the great disadvantage of knits is that the threads and yarns shift relative to one another and therefore that the textile as such is not very well fixed.

By arming the knit with an adhesive which typically has a depth of penetration between 5 μm and 200 μm, the longitudinal and transverse threads, surprisingly, are fixed entirely adequately, so producing a functioning cable bandaging tape.

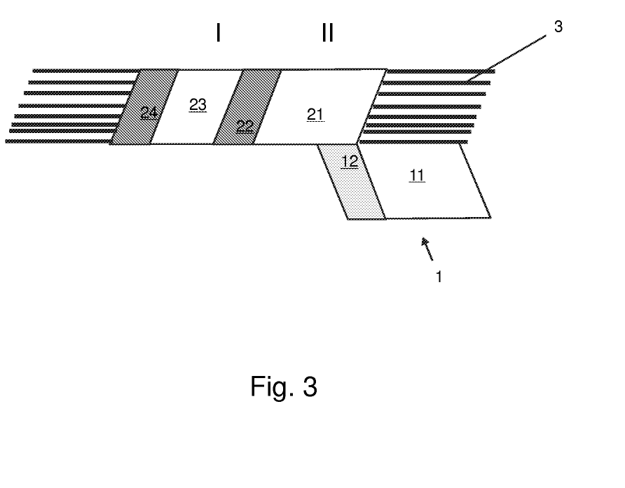

FIG. 3 shows a section of a cable harness which is composed of a bundle of individual cables 7 and which is jacketed with the adhesive tape 1 of the invention. The adhesive tape 1 is guided in spiral movement around the cable harness.

The section of the cable harness that is shown has two winds I and 11 of the adhesive tape 1. Further winds would extend towards the left; these are not shown here.

The carrier material 11, 21, 23 is coated on one side with an adhesive 12, 22, 24, application taking place in the form of a strip in the longitudinal direction, whose width is lower than that of the carrier material 11, 21, 23 of the adhesive tape 1.

The cable harness is jacketed in such a way that the strip of adhesive 12, 22, 24 adheres fully to the carrier material 11, 21, 23 of the adhesive tape 1. Sticking of the adhesive to the cables 7 is ruled out.

The adhesive tape 1 embraces (see wind 1) in the width the section 24 and the section 22, and also the open carrier 23 located in between them. The section 22, which belongs to the wind 11, therefore adheres to the section 23. (The section 24 would adhere to the carrier of the next wind situated to the left.) In contrast to the exposed adhesive 12, the sections 22 and 24 are not visible from the outside, which is why the denser shading has been chosen to depict them.

What is claimed is:

1. Adhesive tape, comprising a tapelike carrier composed of a weft insertion knit, and an adhesive coating applied at least to one side of the carrier, the weft yarn in the weft insertion knit being composed of a textured filament yarn.

2. Adhesive tape according to claim 1, wherein the weft insertion knit has a basis weight of between 30 and 200 g/m².

3. Adhesive tape according to claim 1, wherein the weft insertion knit has a breaking force in running direction of 10 daN/(5 cm) to 20 daN/(5 cm) and a breaking elongation in running direction of 30% to 50%.

4. Adhesive tape according to claim 1, wherein the weft insertion knit has parallel courses.

5. Adhesive tape according to claim 1, wherein on the weft insertion knit there is no further layer provided in the form of a film or another textile carrier.

6. Adhesive tape according to claim 1, wherein the whole weft insertion knit is composed of polyester or polyamide.

7. Adhesive tape according to claim 1, wherein the adhesive tape has a noise damping in accordance with LV312 or BMW GS 95008-3 in single-ply measurement of more than 3 dB (A).

8. for a method of jacketing elongate material, comprising wrapping the elongate material in an axial direction by the adhesive tape, or guiding the adhesive tape in a helical spiral around the elongate material.

9. Elongate material jacketed with an adhesive tape according to claim 1.

10. Elongate material according to claim 10, which is a cable loom.
